(19) United States
(12) Patent Application Publication
(10) Pub. No.: US 2023/0362807 A1
(43) Pub. Date: Nov. 9, 2023

(54) DATA DRIVEN ENERGY EFFICIENCY IN OPEN RADIO ACCESS NETWORK (O-RAN) SYSTEMS

(71) Applicant: Radisys Corporation, Hillsboro, OR (US)

(72) Inventors: Rajendra Prasad Kodaypak, Sammamish, WA (US); Prakash Sivasubramanian, Tigard, OR (US)

(21) Appl. No.: 17/810,593

(22) Filed: Jul. 1, 2022

Related U.S. Application Data
(60) Provisional application No. 63/364,410, filed on May 9, 2022.

(51) Int. Cl. H04W 52/02; H04W 24/10

(52) U.S. Cl. CPC H04W 52/0203; H04W 24/10

(57) ABSTRACT

Disclosed is a data analytics driven metering solution for next-generation mobile networks evolution that can initiate triggers based on rules within the converged domain data analytics function (CDDAF), extract the energy efficiency data from the domain specific slices and network functions within the slice, correlates with the user traffic patterns on a location/time/service scale, and takes actions to conserve energy resources across the networking domains. The CDDAF securely exposes APIs towards external agencies such as site owners with data insights that are used by them to enhance life cycle management of site-specific assets and resources.

This application claims priority benefit of U.S. Provisional Patent Application No. 63/364,410, filed May 9, 2022, which is hereby incorporated by reference in its entirety.

### BACKGROUND INFORMATION

The 5G-enabled telecommunications and information technology industry is in the midst of rapid change. The demand for mobile broadband data consumption, enterprises drive towards digital transformation, and the desire for a broader adoption of 5G technologies has widespread implications across several companies, organizations, educational institutions, and industry verticals. Massive connectivity growth resulting from a wide variety of digital end points to connect globally and exchange information rapidly via the cloud native networking infrastructure could imply that the data generated by such devices and the networks serving these devices amount to attractive monetization opportunities.

FIG. 1 shows a 5G O-RAN reference architecture 100 with a gNB 102 including a radio unit (O-RU 104) and split into the following logical network functions: a central unit (O-CU 106, both control and user plane) and a distributed unit (O-DU 108). The disaggregated O-CU 106 and O-DU 108 network functions are interconnected via standards defined interfaces. An O-RAN (gNB 102) is connected to a 5G core network 110 via 3GPP standardized interfaces. Service-based interfaces for control plane communication within the 5G core (subset of functions shown) are also provided.

FIG. 1 also shows the system architecture for 5G core network 110. As described in 3GPP TS 23.501, 5G core network 110 includes an access and mobility management function (AMF), user plane function (UPF), session management function (SMF), authentication server function (AUSF), a network exposure function (NEF), a unified data management (UDM), a unified data repository (UDR), a short message service function (SMSF), a non-3GPP interworking function (N3IWF), and other 5G core network functions.

As indicated in FIG. 1, gNB management 112 and core network functions management 114 are provided via their respective domains, as they could be from different suppliers.

Although 3GPP Rel. 17 standards (3GPP TS 28.310, December 2021) have specified some aspects relating to energy efficiency, the concepts are rudimentary in nature. Energy efficiency solutions that are critical for next generation of services delivery should be innovative, disruptive, and enhance the value to service providers as well as the ecosystem partners while paving the way for seamless 6G evolution.

### BRIEF SUMMARY OF THE DISCLOSURE

Disclosed are embodiments facilitating an energy efficiency solution for mobile networks. The embodiments allow mobile network operators (MNOs) to utilize advanced intelligent monitoring and data-driven proactive methods to conserve network resources effectively.

This disclosure describes a converged domain data analytics function (CDDAF) that helps a service provider extract real-time data insights from each of the subtending domains via open standards interfaces/APIs. The CDDAF employs an internal policy driven framework to share such insights to the cross-domain networking functions involved in path selection and decision making for routing application/service flows across these domains. In addition, it also ensures that the services delivered to the digital endpoints are satisfactorily met by extracting data insights from the digital endpoint management data analytics function.

The adoption of 5G broadband wireless technologies by global service provider community will help drive massive connectivity models resulting in explosive information-rich networking environments. This offers a huge opportunity for data mining and resulting monetization opportunities with built in security/privacy policies. The ability to process and analyze such large amounts of data across multiple networking domains via the CDDAF within a service provider's 5G network leads to reduced complexity, intelligent automation driving operational agility and enhanced efficiency throughout their network infrastructure investments as well as their supply chain business models. Service providers can differentiate themselves in the industry with their competitive networking infrastructure, data driven intelligence, dynamic self-correction and services delivery model. Regardless of the size of the network or its sharing model with virtual network operators, real-time data access and analytics help build AI/ML enabled models, which may be used to predict and prioritize service degradations before network performance takes a hit or outages occur. Such data analytics translates into new revenue opportunities for all customers improving a business's bottom line.

These efficiencies further enable cost reductions via data driven geotargeted network and infrastructure as well as service layer optimizations resulting in enhanced QoE, increased customer satisfaction and minimizing subscriber churn. Such data insights will also allow them to drive geotargeted energy efficiencies in data centers as well as outside plant environments and use these common facilities in turn to build or expand further to enable new services and business opportunities.

Additional aspects and advantages will be apparent from the following detailed description of embodiments, which proceeds with reference to the accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a 5G O-RAN reference architecture, according to the prior art.

FIG. 2 is a block diagram of a network showing a CDDAF, according to one embodiment.

FIG. 3 is a block diagram of the network of FIG. 2, showing mobile terminated application delivery options over multiple transport paths, configured by the CDDAF, to be taken by the end user's mobile IP data packets.

FIG. 4A, FIG. 4B, FIG. 4C, and FIG. 4D are portions of a flow diagram collectively showing an example of a CDDAF facilitating selection of a UPF in connection with UE mobility.

FIG. 5 is a block diagram showing a RAN site analytics reporting example, in accordance with one embodiment.

FIG. 6 is a block diagram of a hierarchical CDDAF configurations in a multi-vendor network environment, in accordance with one embodiment.

FIG. 7 is a timeline showing 5G traffic patterns across the networking domains, in accordance with one embodiment.

FIG. 8A, FIG. 8B, and FIG. 8C are portions of a message sequence diagram collectively showing analytics driven energy efficiency triggers in the network of FIG. 6, in accordance with one embodiment.

FIG. 9 is a flow chart of a routine in accordance with one embodiment.

FIG. 10 is a block diagram showing components for providing a CDDAF or other data analytics function, in accordance with one embodiment.

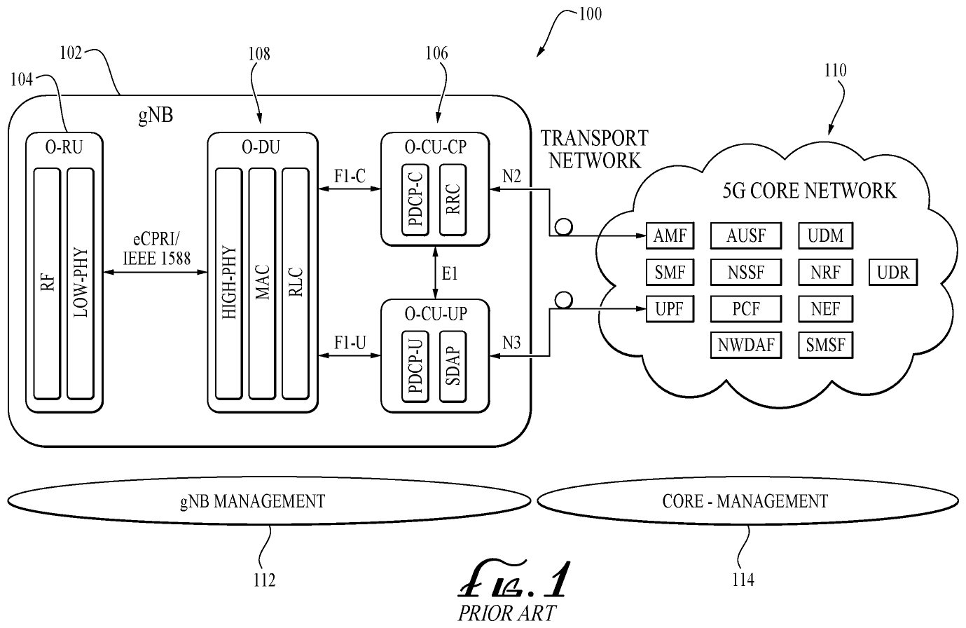

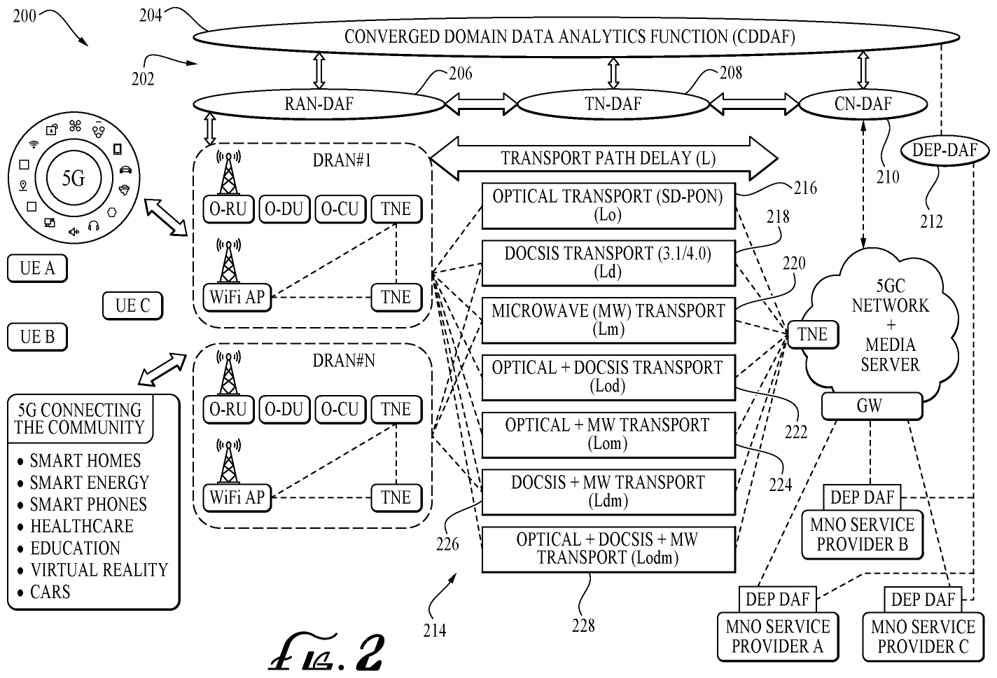

### DETAILED DESCRIPTION OF EMBODIMENTS

As private 5G networks embrace 3GPP/O-RAN standards-driven architectures and adopt the use of disaggregated software defined multi-radio access, transport, and core network functions, the data insights provided by each of the networking domains become important to deliver net value proposition to an end customer (e.g., residential, enterprise, wholesale, and the like). The combination of this network in conjunction with Wi-Fi 6 adds to the overall challenge. These networks are being built by a variety of service providers including the traditional ones such as MNOs and multiple system operators (MSOs). FTTX and new entrants are also trying to disrupt the industry with their unique value propositions.

Due to the disaggregated nature of the networking functions and solutions delivered by multiple vendors needing to interwork together within a specific domain as well as across multiple domains when operating in a public/private/hybrid cloud environments, there could be potential challenges and delays in rolling out new networks as well as services. These could be due to their customizations beyond standards specifications within a given domain that may not have been extensively validated due to lack of proper measurement tools and methods, data insights, intelligent automation methods in a continuous integration (CI) and continuous delivery (CD) (CI/CD) software pipeline delivery model etc. Lack of their ability to expose their performance metrics via suitable and actionable data insights or analytics could hinder their development and delivery progress and impact their time to market.

Carriers could streamline their networking operations and proactively address such interworking challenges by introducing intelligent domain specific analytics functions within their access, transport, and core networks. While this approach offers some understanding of the challenges of networking within a given domain, lack of visibility via a converged domain function inhibits their agility and ability to realize the full potential in terms of services differentiation. This could potentially imply that lack of data insights to qualify and quantify their value proposition to end customers and businesses and a resulting subscriber/enterprise/service churn is lost revenue opportunity as well. Carriers cannot afford to do that and to stay competitive, and so there is a need to develop comprehensive data analytics driven intelligence in their networking solutions that will continue to evolve as well as services delivery model.

With a wide variety of transport technologies available to connect the multi-radio access and core networking domains, the actual transmission path behaviors—i.e., for the data packets tagged to a specific application or service flow traverse from a source to its destination—could influence its timely delivery and quality. With transport domain specific data analytics function, it could be possible to select the optimal transmission path in terms of latency, delay, jitter, congestion, quality of service marking and agreement for that application flow, however, this may not satisfy the desirable end-to-end (E2E) service level agreement (SLA) for that service due to lack of visibility of that flow influenced by other inter-connecting domains. The introduction of access and core networking domain analytics functions could help alleviate their domain specific challenges as these operate independently.

To simplify the private 5G networking complexity and enhanced services delivery in information rich environments such as factories, hospitals, shopping malls, industrial hubs where massive connections give rise to giant volumes of data, real time data analytics becomes important for operational success.

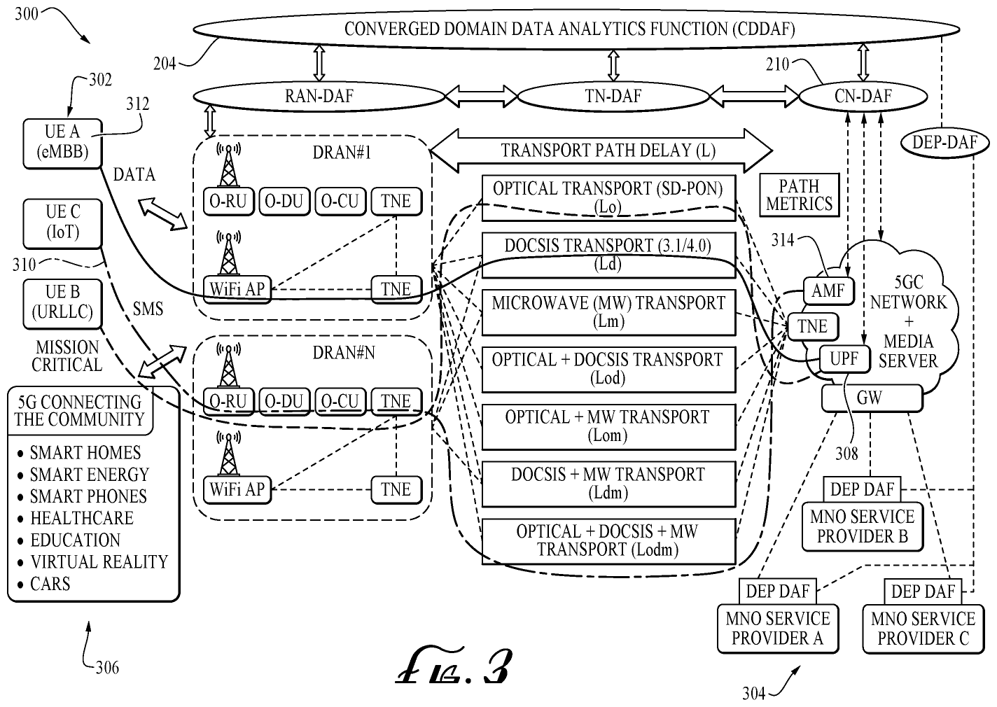

FIG. 2 shows an example role of a CDDAF in an E2E network 200, including CDDAF interfaces and communications 202. The following software defined data analytics functions may be realized as physical, virtual, or containerized services.

A CDDAF 204 is a shown as flexible software-defined framework with pluggable interfaces. It interfaces with a Radio Access Network Data Analytics Function (RAN-DAF 206), a Transport Network Data Analytics Function (TN-DAF 208), a Core Network Data Analytics Function (CN-DAF 210), and a Digital Endpoint Data Analytics Function (DEP-DAF 212). RAN-DAF 206, TN-DAF 208, and CN-DAF 210 provide data insights to CDDAF 204 continuously. A policy driven engine within CDDAF 204 ensures dynamic rules are engaged for application triggers.

RAN-DAF 206 interfaces with CDDAF 204 via open standards API, interfaces with TN-DAF 208 via open standards API, and interfaces with CN-DAF 210 via CDDAF 204 and open standards API.

TN-DAF 208 interfaces with CDDAF 204 via open standards API, interfaces with RAN-DAF 206 via open standards API, and interfaces with CN-DAF 210 via open standards API.

CN-DAF 210 interfaces with CDDAF 204 via open standards API, interfaces with TN-DAF 208 via open standards API, interfaces with RAN-DAF 206 via CDDAF 204 and open standards API, and enables service-based interfaces with network functions not supported by standards today.

FIG. 2 also shows multiple transport network architecture options 214 available for mobility services delivery. Each path has its unique delay/loss value (L) that is continuously determined via a software agent-based approach. The path performance metrics are fed into TN-DAF 208. CDDAF 204 and TN-DAF 208 exchange the data using Open APIs.

An optical transport 216 (Delay: Lo) is a direct fiber connection. In some embodiments, optical transport 216 includes a software defined PON architectures, such as GPON/XGS-PON/C-PON, or the like.

A DOCSIS transport 218 (Delay: Ld) may include DOCSIS 3.1 or DOCSIS 4.0.

A microwave transport 220 (Delay: Lm) is for line-of-sight communications.

FIG. 2 also shows combinations of transport options, such as, optical+DOCSIS transport 222 (Delay: Lod), optical+microwave transport 224 (Delay: Lom), DOCSIS+microwave transport 226 (Delay: Ldm), and optical+DOCSIS+microwave transport 228 (Delay: Lodm).

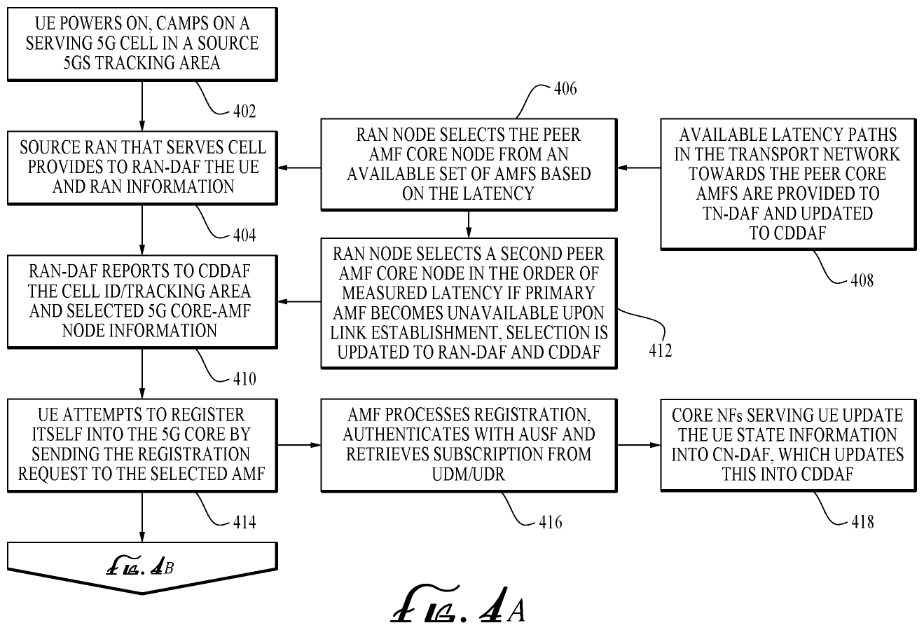

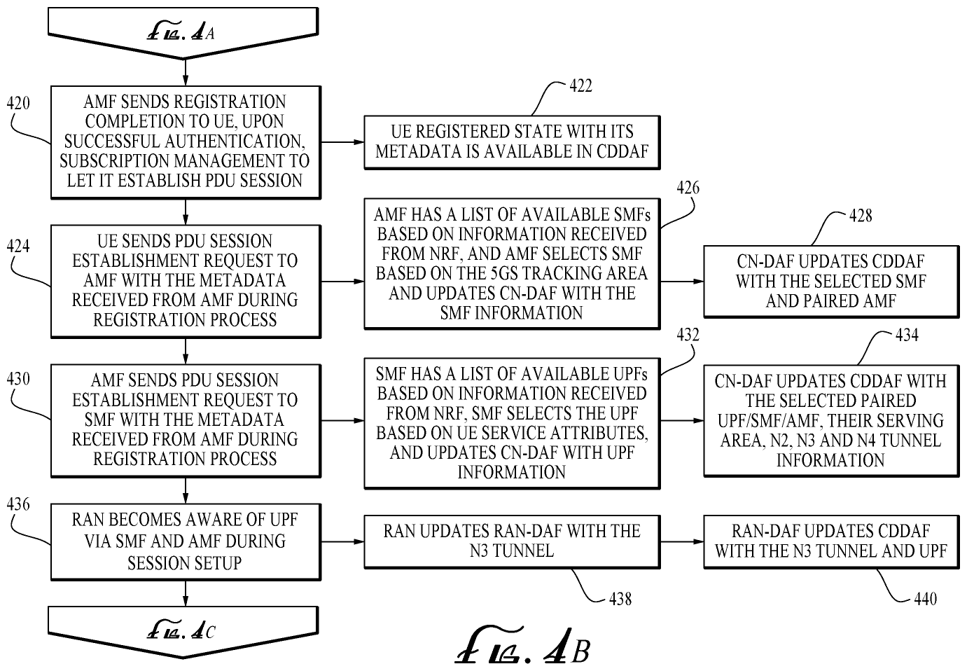

FIG. 3 shows an example of mobile terminated application delivery options 300. Multiple transport paths can be taken by the end user's mobile IP data packets when traversing from an originating source (UE) 302 to a target destination 304 (application server).

Lack of intelligence of the available end-to-end transmission paths across cross-functional domains and their real time path behaviors can negatively impact bandwidth intensive application flows including on-demand streaming, peer-to-peer, broadcast/multicast group conversational media and messaging services.

For example, a transport domain specific analytics functions (assuming it is even available) may cater to the needs of the functions supported by that particular domain. They may provide path latency metrics between the transport network terminating points only without having any visibility into their adjacent domains (i.e., RAN and core domains). Similarly, in the case of 5G mobile terminated voice services delivery (5G services delivery 306), when the voice packets arrive at the core network media server processing engine, they are routed to a user plane function (UPF 308) before being routed via the transport network to the RAN serving the end user. In the case of 5G mobile terminated messaging services 310 via control plane delivery, SMS packets arrive at the core network messaging node, SMSF that needs to select the right AMF and/or N3IWF before being routed to the end user based on user registration in 3GPP/non-3GPP radio access technology. Having access to only a core domain specific analytics functions (again, assuming it is even available) will just give peer node connectivity visibility and data insights into the selection of the targeted core network functions required to complete the call processing.

To ensure a fully seamless and unified service layer experience targeted for a given end user's application (data/voice/video/IP-SMS/public safety/NAS-SMS/IoT/Multimedia/Emergency/ALERTing services etc.) in a software defined disaggregated networking infrastructure, convergence across multi-domains becomes increasingly beneficial. It is helpful to derive network layer intelligence in a complex environment with finer granularity and apply that selectively using policy framework to targeted applications with SLA requirements.

CDDAF 204 helps service providers build such software defined intelligence and policy driven control that can facilitate communication between network functions within a specific domain and across multiple domains via open standards API triggers sensing packet data flows. Such an architecture allows the individual domains to evolve with new networking functions in support of new services while leveraging the common interfaces and API framework to drive new data insights.

With CDDAF interactions using open standards interfaces towards its subtending AF functions (RAN-DAF 206, TN-DAF 208, CN-DAF 210, and DEP-DAF 212), the core network routing engine can not only select the right peer network functions within its own domain using the data insights from CN-DAF 210 but also a transport path that yields the best possible next hop based on interaction with TN-DAF 208 and CDDAF 204 and a suitable terminating point in the RAN domain via RAN-DAF 206 and CDDAF 204. It can also leverage insights from DEP-DAF 212 and CDDAF 204 to ensure real time E2E service is guaranteed as reported by DEP-DAF 212. CDDAF 204 can be readily extended to support data analytics framework for finer granular sub-domain analytics functions to meet specific geographic deployment, industry vertical, service delivery needs.

Due to dynamics of mobility, user patterns change as they move in and out of 3GPP/Non-3GPP (5G/Wi-Fi) coverage area. Hence, CDDAF 204 provided data insights based on learning end user mobility as well as application consumption behaviors, AI enabled models, become extremely valuable to the cross-domain networking functions to steer the traffic flows along the transmission paths that provide guaranteed SLAs.

Mobility workloads in datacenters may need to be dynamically offloaded/relocated into edge locations to meet the real time capacity demands of the underlying infrastructure as well as alleviate traffic congestions in certain centralized locations. To perform this offload seamlessly between data center locations (local edge/near edge/far edge) with varying levels of performance in terms of transmission path behaviors, the service provider needs to have full visibility into the data insights. These real time metrics will help them to utilize their policy framework to adapt their rules dynamically to be able to send the right triggers towards the core network functions to take appropriate actions that are measurable.

For example, if a centralized data center that hosts the control and user plane core network functions is targeted to process mission critical workloads associated with emergency/public-safety/group communications calls and there is an impending or planned disruption in a given geographical grid area, the use of CDDAF enabled data insights will help the core network DAFs serving the data center locations to proactively cooperate, align and drive intelligent selection/offload of user plane functions by the control plane functions based on its API triggers. This is a powerful tool in the service provider's toolkit to help balance and optimize their mobility workloads continuously across the compute resources available at the edge locations while mitigating any disruptions to network operations, support and service delivery.

CDDAF 204 acts as a centralized repository for the data insights and intelligence collected across cross-functional networking domains and has policy driven framework for triggers via east-west and north-south interactions towards its peers. 5G networks designed with such cross-layer and cross-domain intelligence in software can be easily and flexibly upgraded to evolve to the next-gen technologies such as 6G/WiFi7 etc.

The CDDAF framework allows for hierarchical relationships with open standards interfaces. For example, in a large nationwide deployment, the CDDAF could have a parent-child relationship with the parent CDDAF interfacing with child CDDAF instances that are targeted for specific serving regions or service areas. These child CDDAFs may have their own subtending regional domain specific DAFs which could be segregated by vendor specific solutions as well as a mix of multi-vendors in a single region. Such complex deployments demand robust and resilient network operations with finer granularity of performance metrics at the domain DAF level. By supporting a hierarchical relationship with open standards interfaces and API triggers, the CDDAF framework can support resilient operations in such large networking environments thereby delivering stellar network functionality and services delivery.

The CDDAF framework facilitates domain specific network expansion as new radio access, transport and core networking functions are introduced to support new services. Due to the global demands for mobile broadband, 5G roaming services will expand as operators launch 5G networks. The CDDAF can provide data insights into global carrier's roaming services delivery based on bilateral agreements in place. This will help them to optimize and expand their network infrastructure based on user data traffic and mobility patterns as they roam in and out of a given carrier's network. The power of data driven intelligence in 5G networking will pave the way for new business models as carriers plan to design, develop and deploy rich services such as 5G CV2X, Autonomous driving with collision avoidance systems, 5G health/telemedicine, modernizing streaming applications for education etc.

In a 5G services delivery 306, depending on the disaggregated network architecture and service provider's deployment as well as policies, the domain specific networking functions can route the application layer packets. CDDAF 204 could trigger changes to both control and user plane functions via CN-DAF 210. Examples are as follows.

An end user (UE 312) moves from a source service area to a target service area, however, the session is still anchored by a Core Control Plane function optimal for serving the source service area. CDDAF 204 could extract analytics of UE 312 and detect mobility patterns to determine that the session could be steered to a more optimal Core Control Plane function such as AMF/SMF 314 for serving in the target service area.

Similarly, CDDAF 204 could also learn about the network usage such as UPF 308 capacity/utilization/latency/services in use and user mobility as well as service patterns during time of day, to trigger redirection of user plane data from a centralized UPF to an edge UPF. For instance, a UPF originally selected to serve a given end user for a targeted service may not be optimal during the life of an end user's best effort data session or with the dynamic addition of a critical service such as autonomous vehicle that needs to make rapid real time decisions for collision avoidance in a given location or a mission critical public safety/emergency alerting service delivery. In order to relocate the user's data forwarding plane from a given source UPF to a targeted UPF and/or multiple UPFs that meet the end user's SLA based on the analysis of the networking and device behaviors, the session modification procedure has to be initiated to shift the N3 tunnel endpoint from a source UPF to a target UPF.

It is possible that the source UPF may be pooled with other UPFs in the data center location however the source UPF may have transient congestion is sues due to serving multiple services as well as handling a large number of simultaneously active users in a dense urban environment. The analytics driven data insights from CN-DAF 210 will demand the existing and/or incoming new sessions to be anchored into a different target UPF within that pool.

Alternately, the target UPF for optimal SLA for a given service could be in a different geographic area in closer proximity to the cell site serving the end user. The same could be true for control plane network functions such as AMF and SMF that are used in facilitating the session transfer. Hence, the data insights made available by CDDAF in conjunction with CN-DAF 210 will facilitate the API trigger from CN-DAF 210 via an NEF to reselect the target control (AMF/SMF) and UPF that will maintain a superior end user experience independent of the mobility dynamics of the end user with multiple service flows.

The 3GPP standards have defined generic methods for control and user plane functions selection based on a set of attributes as per 3GPP TS 23.501. A single user could have several service flows supported within a single PDU session served by multiple UPFs. However, these methods lack the ability to do smart selection on a finer service granularity level taking into account cross-domain intelligence. The disclosed approach with CDDAF 204 and CN-DAF 210 will help service providers to drive innovative means of enabling new services, maintain their QoS, QoE, SLA on a per service basis with the help of enhanced API triggers via the NEF.

CN-DAF 210 initiates triggers based on continuous learning about the network from its interaction with various domains (RAN/Transport/Core and End Users/DEP) and user services from CDDAF 204. The trigger from CN-DAF 210 is a direct API call to drive targeted CP and/or UP function relocation so that the sessions are seamlessly handled without any end user service impacts.

The service quality measure corresponding to a given application flow (data, voice, video, group talk, emergency call, multimedia messaging, etc.) can be monitored, tracked with mobility patterns and reported to CDDAF 204 for trending. These can be detected via DPI of the packet captures across the interfaces within and between the networking domains.

CN-DAF 210 further interfaces towards the core network control and user plane functions via the standards defined NEF as a gateway/proxy with an enhanced API trigger. For networks supporting legacy services such as LTE, the NEF could be a combined entity (NEF+SCEF) to allow seamless transitions of users between 5G and LTE technologies.

The enhanced API trigger mechanism between CN-DAF 210 and NEF interface includes the various system attributes listed below, beyond the standards specifications that are useful in allowing the core network functions reselection thereby delivering the targeted end user applications/services during the life of their active data/messaging sessions. Examples of the attributes include: location with finer granularity in terms of the street address/building/floor/zip code; serving radio cell; 3GPP tracking area/non-3GPP tracking area; PLMN; service area; device identity, device type, device priority access; device subscription; device analytics; device mobility; device roaming restrictions, policy enforcements; network slicing support, number of slices supported; quality of service (flow indicators); measured transport path latency, jitter; desirable transport path latency, jitter; service level agreement (SLA) for specific flow—data, voice, messaging, video, AR/VR/xR, live streaming, CV2X, gaming, MCPTT, interactive services, visual content, industrial automation, transportation etc.; and service rate plan for that device/end user.

For example, a data session can be setup with a specific control plane and user plane network function during the initial call establishment phase. During this data session setup, the latency of the transmission path can be taken into account besides the above attributes based on the converged domain specific data insights provided by CDDAF 204. However, due to the dynamics of the end user mobility conditions and switching across radio access technologies, the real-time aspects of the user service delivery could be impacted if the initial selected core functions are not optimal.

Hence the continuous visibility of data insights received from CDDAF 204 are helpful for CN-DAF 210 to maintain the optimal networking functions within the CN domain as well as drive an intelligent reselection method of the control and user plane network functions via the NEF initiated triggers. For optimal distribution of session handling during mobility conditions, the control plane functions such as the AMF and SMF within a given service area can be reselected based on NEF initiated API trigger with the enhanced system attributes to meet optimal performance in terms of the session setup/teardown times.

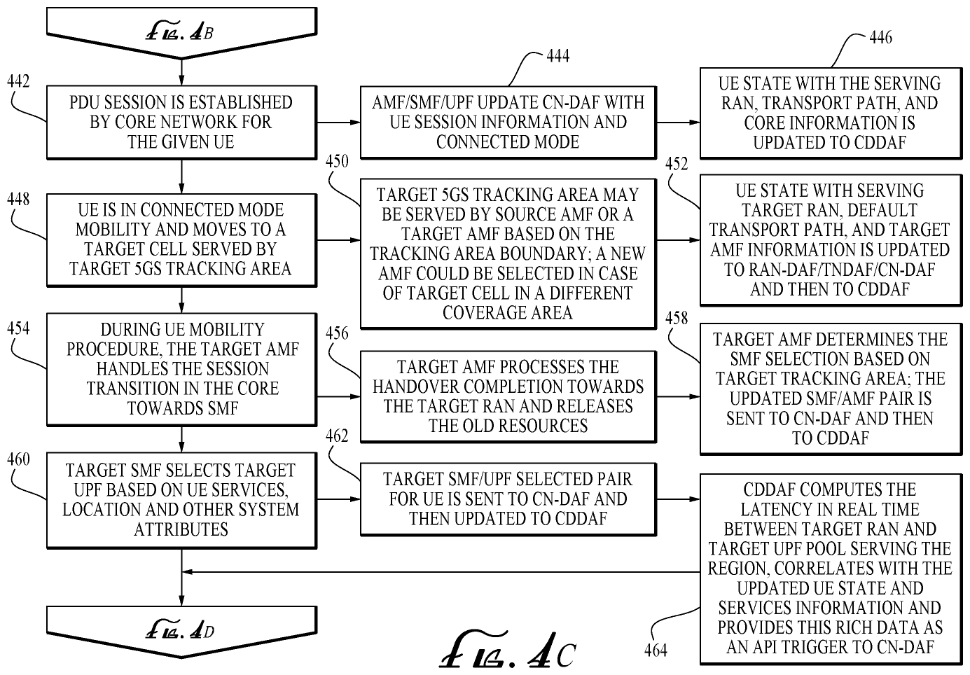

FIG. 4A-FIG. 4D show an example of how CDDAF 204 provides the data insights needed for CN-DAF 210 to drive intelligent core network functions selection during initial call establishment and re-selection to account for the mobility dynamics of the end user along with the addition/deletion of new services.

FIG. 4A shows that in block 402, a UE powers ON and camps on a serving 5G cell in a source 5GS tracking area. In block 404, a source RAN that serves the cell provides to RAN-DAF 206 the UE and RAN information. In block 406, the RAN node selects the peer AMF core node from an available set of AMFs based on the latency. In block 408, available latency paths in the transport network towards the peer core AMFs are provided to TN-DAF 208 and updated to CDDAF 204. In block 410, RAN-DAF 206 reports to CDDAF 204 the cell ID/tracking area and selected 5G core-AMF node information. In block 412, the RAN node selects a second peer AMF core node in the order of measured latency if primary AMF becomes unavailable upon link establishment, selection is updated to RAN-DAF 206 and CDDAF 204. In block 414, the UE attempts to register itself into the 5G core by sending the registration request to the selected AMF. In block 416, the AMF processes registration, authenticates with an AUSF and retrieves subscription from UDM/UDR. In block 418, the core NFs serving UE update the UE state information into CN-DAF 210, which updates this into CDDAF 204.

FIG. 4B shows that in block 420, the AMF sends registration completion to the UE and, upon successful authentication, subscription management to let it establish PDU session. In block 422, UE registered state with its metadata is available in CDDAF 204. In block 424, the UE sends PDU session establishment request to the AMF with the metadata received from AMF during registration process. In block 426, the AMF has a list of available SMFs based on information received from NRF, and AMF selects SMF based on the 5GS tracking area and updates CN-DAF 210 with the SMF information. In block 428, CN-DAF 210 updates CDDAF 204 with the selected SMF and paired AMF. In block 430, AMF sends PDU session establishment request to SMF with the metadata received from AMF during registration process. In block 432, SMF has a list of available UPFs based on information received from NRF, SMF selects the UPF based on UE service attributes, and updates CN-DAF 210 with UPF information. In block 434, CN-DAF 210 updates CDDAF 204 with the selected paired UPF/SMF/AMF, their serving area, N2, N3 and N4 tunnel information. In block 436, the RAN becomes aware of UPF via SMF and AMF during session setup. In block 438, the RAN updates RAN-DAF 206 with the N3 tunnel. In block 440, RAN-DAF 206 updates CDDAF 204 with the N3 tunnel and UPF.

FIG. 4C shows that in block 442, a PDU session is established by core network for the given UE. In block 444, AMF/SMF/UPF update CN-DAF 210 with UE session information and connected mode. In block 446, UE state with the serving RAN, transport path, and core information is updated to CDDAF. In block 448, the UE is in connected mode mobility and moves to a target cell served by target 5GS tracking area. In block 450, the target 5GS tracking area may be served by source AMF or a target AMF based on the tracking area boundary. A new AMF could be selected in case of target cell in a different coverage area. In block 452, UE state with serving target RAN, default transport path, and target AMF information is updated to RAN-DAF 206m TN-DAF 208, and CN-DAF 210 and then to CDDAF 204. In block 454, during UE mobility procedure, the target AMF handles the session transition in the core towards SMF. In block 456, target AMF processes the handover completion towards the target RAN and releases the old resources. In block 458, target AMF determines the SMF selection based on the target tracking area. The updated SMF/AMF pair is sent to CN-DAF 210 and then to CDDAF 204. In block 460, target SMF selects target UPF based on UE services, location and other system attributes. In block 462, target SMF/UPF selected pair for UE is sent to CN-DAF 210 and then updated to CDDAF 204. In block 464, CDDAF 204 computes the latency in real time between target RAN and target UPF pool serving the region, correlates with the updated UE state and services information and provides this rich data as an API trigger to CN-DAF 210.

With reference to block 464, since CDDAF 204 is aware of the UE state as well as the subscribed services information, during mobility or handover event triggers between a source cell within a source 5GS tracking area and a target serving cell within a target 5GS tracking area, it will continuously compute the latency for the active UE application flows between the target RAN nodes and the UPFs that are in the proximity of the 5GS target tracking area. Once CDDAF 204 analyzes the user data traffic path latency and updates its internal resource mapping table with the latency metrics vs available UPFs that belong to a UPF pool within that target area, it can initiate an API trigger towards CN-DAF 210 to redirect the UE application traffic associated with a specific QoS flow from a selected target UPF #X within the UPF pool to a target UPF #Y. The UPFs information within the UPF pool serving a given 5GS tracking area is updated into CDDAF 204 via CN-DAF 210 using an upstream API trigger. The downstream API trigger from CDDAF 204 to CN-DAF 210 during UPF relocation or traffic redirection includes the UE identity, target serving cell ID, target 5GS tracking area, target N3 tunnel ID that needs to be switched to the target RAN node, application traffic flow QoS identifier, latency metrics, target UPF capacity utilization, target UPF loading in terms of its relative capacity and resources availability that best serves the UE for that specific application. CN-DAF 210 will use this metadata information to send an associated API trigger to the serving or anchored SMF for the UE's ongoing PDU session to shift the N4 tunnel from the UPF #X to UPF #Y within that UPF pool based on the API metadata received within that trigger. Upon completion of the N4 tunnel switching, the SMF communicates this tunnel along with the new N3 tunnel of the target UPF #Y to the AMF and to the target RAN. At the same time, the SMF communicates this exchange of N3 tunnel information to CN-DAF 210 along with the updated N4 tunnel information with the UPF #Y via the upstream API trigger to CDDAF 204. Now CDDAF 204 is in synchronized state with the targeted UPF #Y within the UPF pool that will exchange the application data traffic towards the target RAN corresponding to the QoS flow. The target RAN upon switching the N3 tunnel with UPF #Y sends an API trigger to RAN-DAF 206 providing the updated N3 tunnel information as well as the UPF #Y identifier to CDDAF 204 via an upstream API trigger. With a correlated view of RAN-DAF 206 API trigger and CN-DAF 210 API trigger, CDDAF 204 state information for the targeted application QoS flow during the mobility event is updated. Thus, CDDAF 204 is able to maintain real time updates of the selected access and core network functions across the cross-functional domains, QoS flows as well as the end-to-end user data transfer information including its SLA being met in real time.

FIG. 4D shows that in block 466, CN-DAF 210 sends an API trigger to the target SMF to modify the N4 session towards the closest identified edge UPF in the regional pool. The SMF that is involved in the modification of N4 tunnels from UPF #X to UPF #Y may need to be relocated in case of that SMF failure due to any reasons such as path or link or node failures. The SMF and CN-DAF 210 maintain a synchronized state as well as heartbeat exchange to keep alive and update any changes in real time to CDDAF 204 via CN-DAF 210. The anchored SMF may receive an API trigger for relocation from CN-DAF 210 based on the continuous evaluation of path latency information of the pooled SMFs as received from CDDAF 204 serving the target 5GS tracking area. This API trigger could include the UE identity, serving cell ID, target SMF with the least transport latency serving the anchored AMF for a given target 5GS tracking area, Data Network Name (DNN), slicing information (S-NSSAI), etc. Upon successful completion of the SMF relocation, the new anchored SMF information needs to be updated back via an API trigger with the updated N4 tunnel information towards UPF as well as N11 tunnel information towards AMF to CN-DAF 210 and CDDAF 204 so that the current UE state and serving core network functions are updated in real time. Thus, CDDAF 204 in conjunction with CN-DAF 210 API exchange is able to maintain a synchronized state of not only the UPF relocation but also the SMF relocation to guarantee the SLA of the application traffic flows. This exchange of SMF and UPF core networking functions involved in the end user's call processing and associated QoS traffic flows can be extended to other network functions in policy and network exposure domain when handling such services on demand.

In block 468, target SMF communicates the updated UPF's N3 tunnel information to target RAN via target AMF. The updated UPF/SMF/AMF information is sent to CN-DAF and then to CDDAF. In block 470, UE's data/service session transfers to the new target RAN, transport and core NFs. In block 472, UE's session, state and services information is recorded in DEP-DAF 212 and synchronized with CDDAF 204. In block 474, UE state is updated in CDDAF 204 with the final selected RAN/TN/CN functions, UE location, services, latency per service, quality of service per flow, service assurance, etc.

There has been an increasing focus in the energy efficiency and green networking initiatives within the telecommunications information and communications technology (ICT) industry. The number of global MNOs committing to net-zero emission targets in the coming years has significantly increased. New ways of designing, monitoring, managing and operationalizing the cloud native mobility networking infrastructure solutions to deliver cost-effective pricing models with value added services drives the need to conserve critical networking resources in an energy efficient manner.

Power consumption reduction is a critical component for MNOs to realize those targets amidst rising utility as well as real estate expenses and hence reduce their operational expenses (OpEx) as well. To optimize geo-location dependent energy consumption, it is important for MNOs to have detailed understanding about the location, environment/climate zones, demography, power sources, backup and failover options, sensitivity to public safety, timing as to where, when, and why a certain amount of energy is consumed, and which factors are influencing this consumption in that geographical area.

Thus, an intelligent data driven, and accurate metering system with reduced manual intervention is disclosed, ensuring that energy consumption in a mobility network can be properly monitored, measured, and optimized with a policy driven rules-based engine. Given the operators have the flexibility to deploy network slices on demand to address a variety of mobility services across the industry verticals, the data driven energy consumption and efficiency models could be incorporated in sliced networks in conjunction with the analytics extracted at the application layers.

By having a cooperative and coordinated management approach across the network slicing domains, it is possible for operators working closely with vendors and manufacturers to trigger, monitor, and take proactive measures to track the energy consumption of domain specific slices and the composite network in live environments, prioritize the critical network resources and traffic workloads across the domains based on geolocation, user subscription services, demands and sensitivity to time of day, policy driven event triggers, emergency situations, and other situations.

Energy savings (ES) solutions where the ES algorithms are executed may be centralized or distributed based on MNO's implementation. They can be executed in the network element management system or distributed at the network element level itself. A centralized ES could have two variants such as the Network Management Centralized ES and Element Management Centralized ES depending on where the algorithms are executed.

For example, in an O-RAN ecosystem, due to the disaggregated nature of the networking functions (O-RU+O-DU+O-CU), there may be network function specific ES solutions as well as composite O-RAN ES solutions. The variations in the infrastructure layer could further drive targeted ES solutions for a combination of hardware and software solutions that rely on such integrated environment.

The MNO or communications service provider (CSP) can deploy networking solutions in licensed and unlicensed spectrum bands with multi-radio access technologies delivering broadband mobility services within a given geographical area. There could be multiple bands within licensed and unlicensed spectrum and the service providers could leverage combination of these band options along with carrier aggregation and dynamic spectrum sharing methodologies within a given access domain or across technology domains to enhance their services delivery model.

For example, a service provider may have a combination of FR1 (operating at less than 7.125 GHz) or FR2 (higher than 12 GHz into the mmWave bands) for 5G/5G-Advanced deployments along with multi-band multi-mode LTE/3G/2G and Wi-Fi 2.4/5/6/6e/7 technologies. In the future, the licensed/unlicensed bands could extend into the terahertz bands as well for providing ultra large channels for higher radio capacity.

To accommodate these varying spectrum bands as well as the underlying infrastructure support to perform the baseband signal processing, packet acceleration as well as the mobile broadband data services and dynamics of mobility operations across multi-radio access technologies within a targeted coverage area, the service providers may ensure that their networking designs are intelligent, flexible, scalable within various domains vertically and laterally with a data analytics driven approach. At the same time, they may drive cost-effective network infrastructure design and operations management by conserving critical energy resources as well.

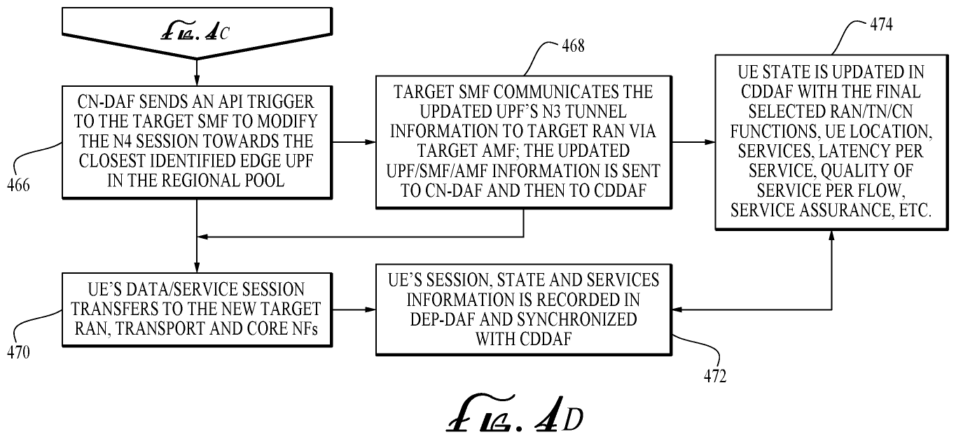

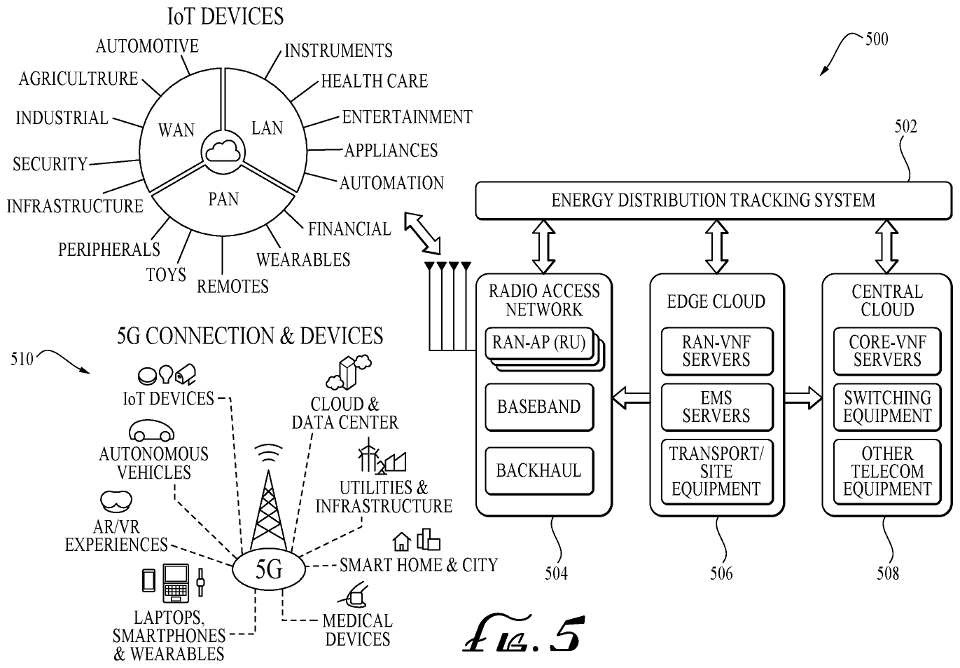

FIG. 5 shows a RAN site analytics reporting system 500 including an energy distribution tracking system 502 for aggregating RAN site energy analytics information from a RAN 504 associated with the RAN domain, an edge cloud 506 associated with the transport domain, and a central cloud 508 associated with the core network domain. The RAN site energy analytics information is received through corresponding APIs in response to event trigger reports. Example triggers events include adding new cell sites in a given area or network attachment status of any particular user equipment (UE) 510. The following table shows example RAN site energy analytics information that could be used by the MNO/service provider to make intelligent decisions in conjunction with the energy efficiency savings requirements.

RAN Site Energy Analytics Information Example

| Analytics | | |
|---|---|---|
| Type | Description | Examples |
| target | demography class | dense urban; |
| network area | | urban; |
| classification | | suburban; |
| | | rural; |
| | | unpopulated |
| | topography class | flat/mountainous/rolling |
| | climate zone | tropical/dry/cold/temperate/polar |
| | network area | topology/geography/demography; |
| | | population/network area/number of |
| | | sites in the targeted area |
| | type of sites in the | wide area/medium range/local or short |
| | target network area | range/relay nodes etc. |
| | sites categorization | MNO's local exchange premises; |
| | | buildings owned/not owned by MNO; |
| | | sheltered/Other sites; |
| | | single MNO/co-located MNO sites; |
| | | sites in network shared mode |
| | radio access | 5G/LTE/4G/3G/2G/combo technology |
| | technology-site | |
| | categorization | |
| | transport backhaul | fiber/copper/cable/wireless/microwave |
| | per site | |
| | network-user/device | age groups/minors |
| | penetration | |
| | services penetration | subscribed packages/QoS/SLA |
| | energy efficiency | EE data volume; |
| | (EE) in the network | EE Coverage Area |
| | area | |
| site | measurement | time duration (day/week/month/year); |
| measurement | duration | start date, start time; |
| | | end date, end time; |
| | | repetition period (e.g., 1 day); |
| | | granularity of measurements (e.g., 1 |
| | | min, 15 min, 1 hr, 24 hr) |
| | temperature class | extremely cold, cold, normal, hot, |
| | | extremely hot |
| | average temperature | normal room temperature |
| | during the test | |
| | energy consumption | method of measurement; |
| | in the site (EC) | measured EC (Wh or kWh |
| | | daily/weekly/monthly/yearly) |
| | traffic offered in the | method of measurement; |
| | site (data volume) | measured traffic data volume |
| | | (bits/bytes |
| | | daily/weekly/monthly/yearly) |
| | site coverage (per | geographical area; |
| | RAT) | designated area; |
| | | % covered |
| | measured EE in | daily EE/weekly EE/monthly |
| | bits/Joule | EE/yearly EE |

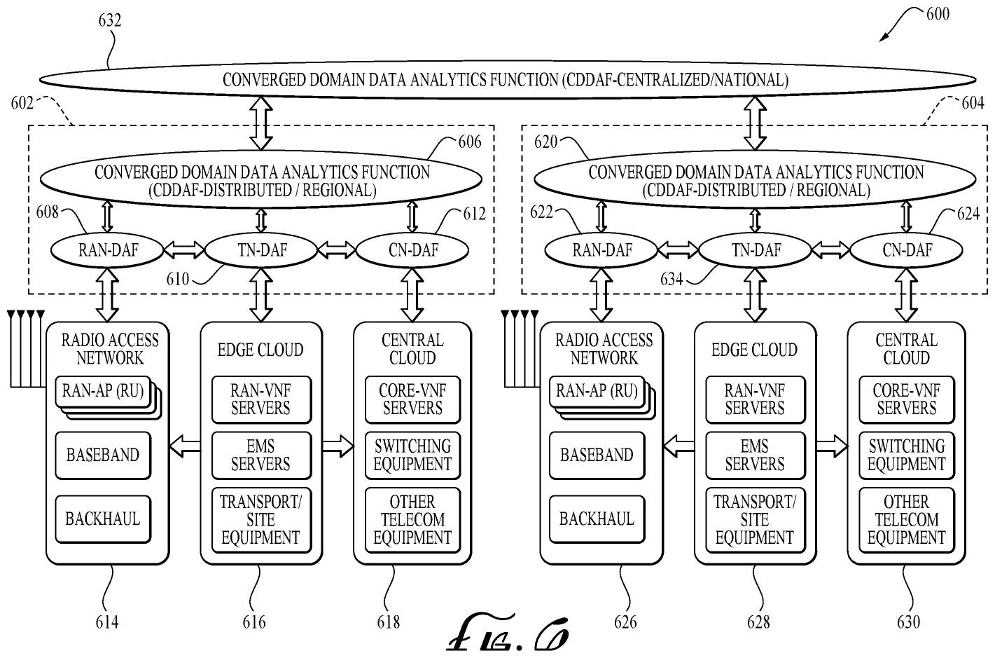

In the example of FIG. 5, energy distribution tracking system 502 represents functionality implemented in CDDAF 204 and its associated RAN-DAF 206, TN-DAF 208, and CN-DAF 210 (FIG. 2), as shown in FIG. 2. For instance, FIG. 6 shows a hierarchical data analytics system 600 that includes a first energy distribution tracking system 602 and a second energy distribution tracking system 604. In this example, first energy distribution tracking system 602 includes a first CDDAF-distributed/regional (CDDAF-D 606), which interfaces with a RAN-DAF 608, a TN-DAF 610, and a CN-DAF 612 (described previously with reference to FIG. 2) for collecting RAN site analytics information from, respectively, a RAN 614, an edge cloud 616, and a central cloud 618 (described previously with reference to FIG. 5). Likewise, second energy distribution tracking system 604 includes a second CDDAF-distributed/regional (CDDAF-D 620), which interfaces with a RAN-DAF 622, a TN-DAF 610, and a CN-DAF 624 for collecting RAN site analytics information from, respectively, a RAN 626, an edge clouds 628, and a central cloud 630.

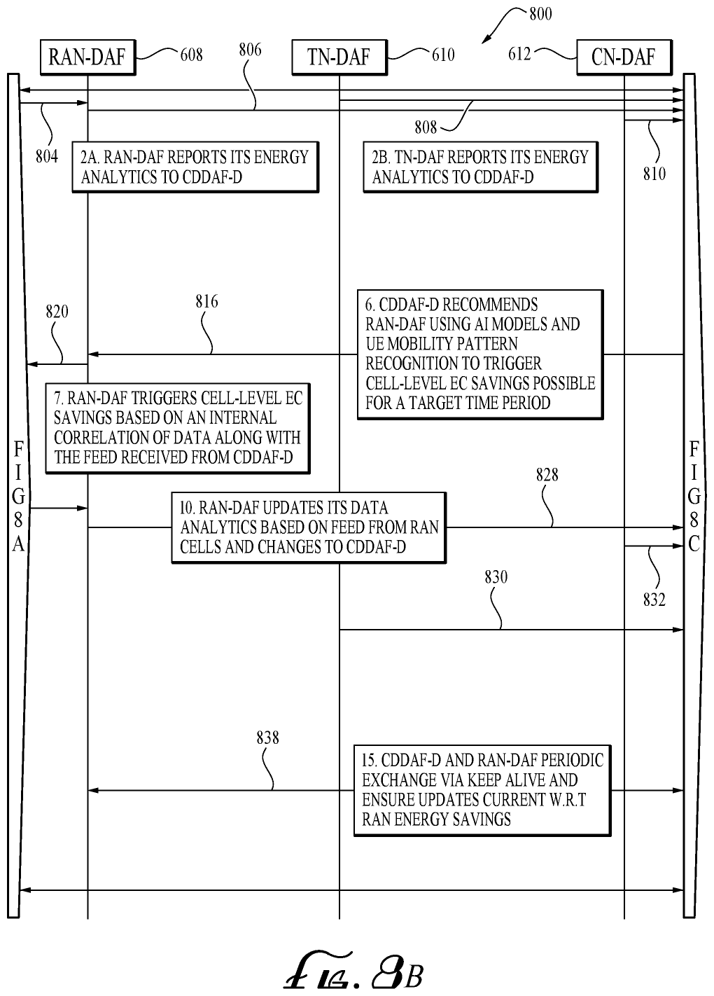

CDDAF-D 606 and CDDAF-D 620 represent a multi-vendor model across the networking domains (RAN/TN/CN) with reporting to a CDDAF-centralized/national (CDDAF-C 632). The two regional network models shown could be dedicated for a given set of slices (eMBB/URLLC/MIoT/CV2X) and split regionally to cover specific parts of the network with targeted slices. The distributed and centralized CDDAF models reflect an equivalent of real-time and non-real-time data driven AI/ML engines that can enable energy efficiency savings at the regional/national level. Additional details of the coordination between distributed and centralized CDDAFs is described later with reference to FIG. 8C.

Mobile network slice energy consumption (MNS-EC) may include base stations within the mobile network covering the RAN slicing portion of the network, backhaul providing transport network slice connections from the base stations to the edge cloud and core network slice, and central cloud core network slice resources providing terminations from network functions within the base stations and transport network slices. The EC for base stations within mobile network covering the RAN slicing portion of the network are based a number of base stations (macro/micro/pico/local) and Wi-Fi access points in the target network site infrastructure, site infrastructure associated with the cell site/base-station/access points, and location specific ICT equipment (actual applications and telecom services) and site support equipment (air conditioning, back-up power, rectifier (AC/DC), lights, security, etc.).

In some embodiments, a CDDAF instance may be slice-service aware and include the analytics associated with the RAN, transport, and core network slice instances covering a given network area and services supported in that area. A predefined number of slices may be supported by a targeted CDDAF instance and, to maintain uniformity across the mobility networking domains and the associated data exchange integrity, the CDDAF may interface with domain specific DAFs (RAN-DAF, TN-DAF, CN-DAF, and DEP-DAF) that serve those specific slices in that targeted area. This would help the service provider/MNO to further quantify the energy consumption per slicing domain and across the composite network.

The software defined RAN is disaggregated with the RU, DU, and CU network functions each performing their own individual tasks. The RF power that is radiated by the RU+Antenna system is critical as it houses the power amplifiers (PA) that amplify the high-frequency RF signals generated in the RU upon conversion from baseband to analog domain and multiple antenna systems that aid in the beamforming to provide enhanced coverage. These PAs, RF transceiver chains and antenna systems consume the maximum power within the RAN depending on several factors including the spectrum bands, channel bandwidths per band, radio coverage, link budget designs, RF emissions, linearity and intermodulation distortion requirements, geographic user density, simultaneous user connectivity and activity, site-specific requirements and demands, etc.

The radiated effective RF power governs the end points/UE's receiving signal strength based on link distance and topography to allow them access into the serving RAN. This power is also regulated in the spectrum bands of operation. The RU units could support operations in licensed and unlicensed spectrum bands within a service coverage area. Within each licensed and unlicensed bands, there could be multiple frequency bands and multiple access methods that can be deployed. Within each band and across multiple bands, there could be carrier components that are contiguous or non-contiguous for dynamic aggregation to enhance the overall radio spectrum efficiency as well as the overall cell capacity. The composite power they radiate effectively at any given site will be dependent on the antenna and radio system configurations. Hence, the site power distribution equipment and operations need to be able to support the monitoring, tracking and selective switching for reliable as well as efficient cell site radio network operation considering the traffic dynamics and time of day delivering superior end user/device experience.

In addition to the RU, the DU and CU consume significant power depending on their hardware and software implementations and the embedded processors that process the high-capacity baseband signals before they are transported using intelligent transport back haul network connections to the core. There could be inline accelerators as well as fast packet processors that need the power boost required for their operation. A subset of these baseband functions could be centralized (e.g., control plane) thus integrated with the core network in a central cloud whereas the user plane data forwarding functions could be distributed and hosted in an edge as well as central cloud locations. Thus, a comprehensive EC implementation strategy based on mobility network data intelligence is important to drive net benefit to the MNOs/CSPs.

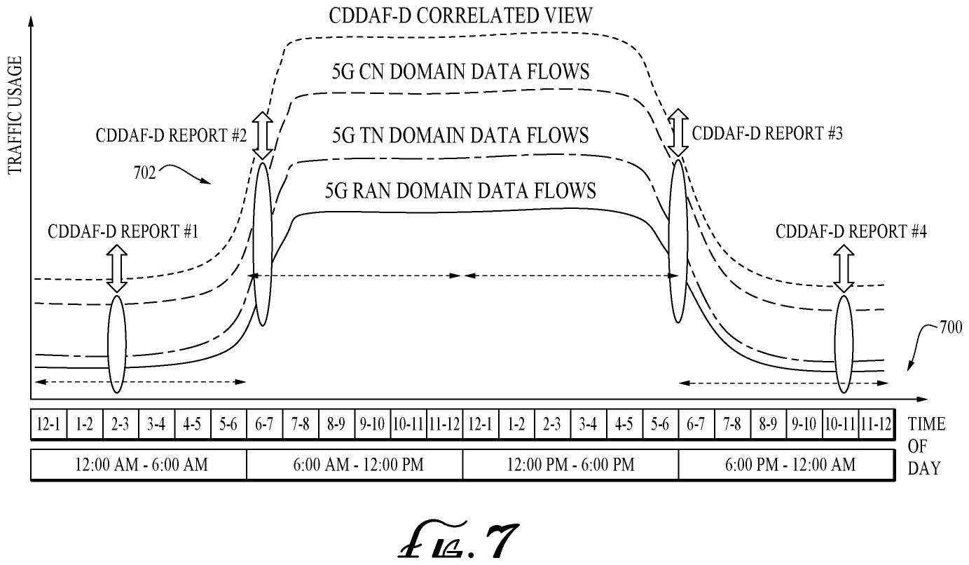

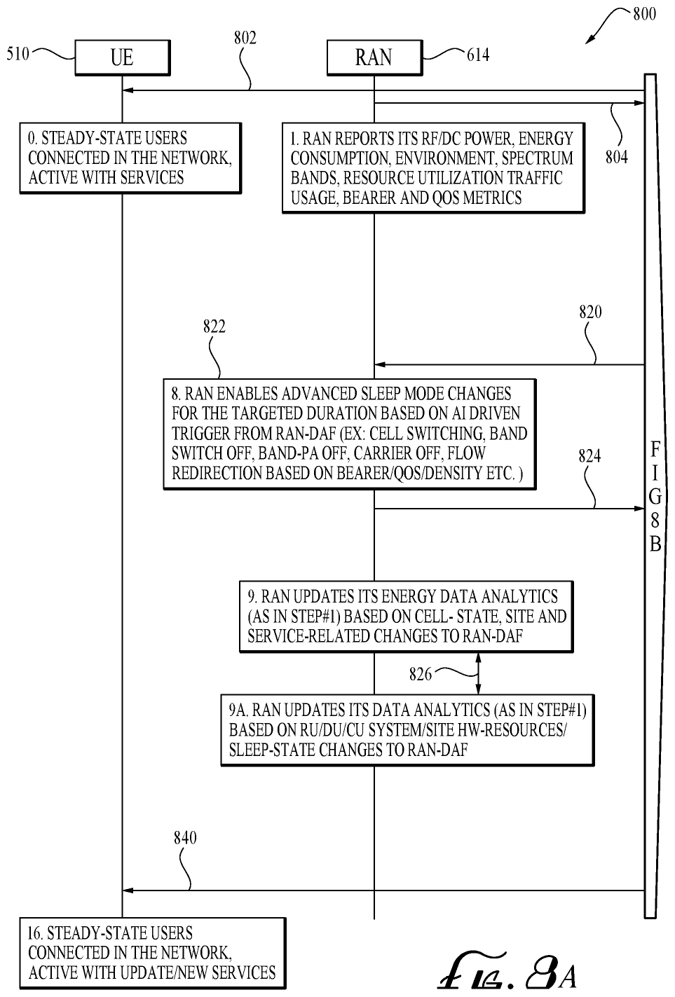

FIG. 7 shows a timeline 700 of 5G traffic patterns 702 across networking domains. At different times along timeline 700, reports are provided to and sent from CDDAF-D 606, as described later with reference to FIG. 8A, FIG. 8B, and FIG. 8C. Specifically, timeline 700 shows four energy analytics reports including time-of day CDDAF-D correlated views across the different domains. In general, the RAN, TN, and CN domain-specific traffic usage reports and their correlated views at any given time/day/duration can be obtained at CDDAF-D 606 based on their reported events, metrics, analysis and targeted thresholds. CDDAF-D 606 has rules defined to correlate the domain specific events with an operator configurable time granularity to ensure the accuracy of data driven decisions fed back to the individual domain analytic functions to take actions for desirable EE outcomes.

FIG. 8A, FIG. 8B, and FIG. 8C collectively show an example process 800 for analytics-driven energy efficiency triggering in a network leveraging hierarchical data analytics system 600 of FIG. 6. Skilled persons will appreciate, however, that functionality of CDDAF-D 606 and CDDAF-C 632 may be consolidated.

An initial state 802 represents users in steady-state connected in the network and active with services. Next, RAN 614 provides to RAN-DAF 608 a report 804 of its RF/DC power, energy consumption, environment, spectrum bands, resource utilization traffic usage, bearer and QoS metrics. Report 804 can be provided dynamically in response to UE triggering events, at predetermined intervals, or on demand in response to signaling from other network functions.

In response to receiving report 804, RAN-DAF 608 provides to CDDAF-D 606 a report 806 of its energy analytics to CDDAF-D 606. An example of the information in the report is shown in the previous table. For instance, a first energy analytics report 806 generated at RAN-DAF 608 includes information about the physical resources utilized in a given serving cell terms of the spectrum bands used, transport blocks per carrier-band, RF power transmitted, antenna layers used, number of connected users in the cell, DC power consumed. Report 806 is generated periodically at RAN-DAF 608 node based on dynamic or static policy driven provisioning by the RAN management system and is sent to CDDAF-D 606. Real-time updates to RAN-DAF 608 system due to changes in the serving network energy analytics, triggered due to a new cell activation/deactivation/modification, may be immediately shared with CDDAF-D 606.

TN-DAF 610 provides a report 808 of its energy analytics, which includes information specific to the transport network domain. For example, a second energy analytics report 808 generated at TN-DAF 610 includes information about the physical resources utilized in a given transport network serving the target RAN network that could include a single cell or cluster of cells in a given service coverage area, and the DC power consumed by such transport resources. Report 806 is generated periodically at TN-DAF 610 node based on dynamic or static policy driven provisioning by the transport network management system and is sent to CDDAF-D 606. Real-time updates to TN-DAF 610 system due to changes in the serving network energy analytics, triggered due to changes in the access aggregation, switching, and routing, may be immediately shared with CDDAF-D 606.

CN-DAF 612 provides a report 810 of its energy analytics, which include information specific to the core network domain. For example, a third energy analytics report 810 generated at CN-DAF 612 includes information about the physical resources utilized across the critical core network functions in a given 5G core network serving the control and user plane call processing functions associated with target RAN network that could include a single cell or cluster of cells in a given service area spread across a single or multiple tracking areas, and the DC power consumed by such core network resources. Report 810 is generated periodically at CN-DAF 612 node based on dynamic or static policy driven provisioning by the core network management system and is sent to CDDAF-D 606. Real-time updates to CN-DAF 612 system due to changes in the serving network energy analytics, triggered due to changes in the core network aggregation functions, switching, and routing based on selection of core network functions distributed in a data center, may be immediately shared with CDDAF-D 606. Examples of metrics collected at CN-DAF 612 associated with the serving users could include initial registrations, authentications, subscriptions, mobility and session management, policy, network exposure services, mission critical events, etc.

CDDAF-D 606 provides a report 812 of its regional analytics to CDDAF-C 632. CDDAF-D 606 shown in FIG. 6 exchanges the data analytics collected across the regional RAN-AF, TN-DAF and CN-DAF networking domains to the CDDAF-C 632. This exchange can happen based on pre-configured static policies at periodic intervals and/or dynamic triggers based on updates to the data reports received by CDDAF-D from any of its domain analytics functions respectively. CDDAF-C 632 can act as a proxy or gateway to securely expose the regional domain specific stats to an external managed service provider to take actionable triggers for their installed user base. An example of this could be an Auto OEM, as an IoT service provider trying to extract the mobility context/state of its installed 5G IoT devices within their automotive fleet in a parking lot or dealership center from the network provider via CDDAF-C, to perform modifications to their firmware, software, energy saving state changes and policies for reporting etc. CDDAF-C 632 has a single pane of management view of the entire network analytics including energy efficiency data at the composite level as well as at the individual domain analytics function (AF) level to be able to synthesize, process and trend the domain specific data insights as well as energy consumption data in the network. Such trending is useful to generate predictive training models based on traffic and/or user mobility patterns within a region, across multiple regions that span boundaries of service areas. This trending and predictive training model is very useful for CDDAF-C to trigger intelligent network and services subscription as well as selection changes via CDDFA-D when users cross certain regional boundaries with heavy traffic intensity and mobility. Such a proactive triggering will help in the regional CDDAF-D coordination and allocation of domain specific network resources and intelligent rerouting with energy efficiency targets taken into consideration where required due to mobility demands.

The series of reports 804, 806, 808, and 812 are triggered by RAN-DAF 608 triggering TN-DAF 610, then TN-DAF 610 triggering CN-DAF 612, and CN-DAF 612 triggering CDDAF-D 606. Although shown in seriatim, in other embodiments reports 804, 806, 808, and 812 may be provided asynchronously from each other such that CDDAF-C 632 correlates them to obtain a view of energy consumption.

Next, CDDAF-D 606 processes 814 the energy analytics reports to generate a cell-level energy consumption configuration 816 for RAN 614. For instance, CDDAF-D 606 processes its data feeds using AI models and UE mobility pattern recognition to extract EE/EC analytics across the networking domains based on active user traffic versus infrastructure resources available, services delivered, and mobility dynamics at the cell level and thereby trigger cell-level EC savings possible for a target time period. The information sources may include AI models with energy analytics data generated based on UE mobility and session management traffic patterns, service subscription profiles, data usage, network resources utilization, applications delivered to meet SLA requirements and their associated success criteria. These models could have been predefined with static policies and/or act upon dynamic triggers when energy analytics reach configurable thresholds on a geographic basis, planned events for a defined duration in a targeted location, type of events, disaster recovery scenarios, priority of events, targeted revenue generation potential, etc. Similarly, CDDAF-C 632 analyzes 818 regional CDDAF-D 606 metrics to extract EE/EC trending at the national level for actionable insights/offloads etc.

Once the data feeds are analyzed, CDDAF-D 606 provides cell-level energy consumption configuration 816 to RAN-DAF 608. CDDAF-D 606 could also generate triggers dynamically towards each domain to extract EE savings. These reports are sent from CDDAF-D 606 towards RAN-DAF 608, TN-DAF 610, and CN-DAF 612 to take specific actions by each of these domain AF's to trigger downstream changes. The downstream triggers could be based on static and/or dynamic policies defined within CDDAF-C 632. An example of such a trigger from CDDAF-C 632 to CDDAF-D 620 would be based on time-series correlation of energy information received from each of the domain specific AF's via CDDAF-D 606 and a planned event in a certain geographic area.

In one embodiment, cell-level energy consumption configuration 816 includes a time-of-day CDDAF-D correlated view of the core-RAN network signaling events associated with registered users/devices and their data connections towards specific core network functions within a RAN serving area. For example, these 5G users/devices could be confined to a given 5GS tracking area or a group of tracking areas that form a 5G service coverage grid/area and served by a set of distributed/centralized user plane core network functions within a given day/time/duration.

In another embodiment, cell-level energy consumption configuration 816 includes a time-of-day CDDAF-D correlated view of the user/device active data connections and associated applications/services with categorized/allocated QoS flows. For example, the flows could be correlated with the service profiles in terms of the allowed data rates in the downlink and uplink for a given IP data connection and associated data network name. These services rely on reliable connections that can deliver enhanced mobile broadband, ultra-low latency, massive IoT, automotive, conversational voice/video flow requirements in terms of their SLAs.

In another embodiment, cell-level energy consumption configuration 816 includes a time-of-day CDDAF-D correlated view of the RAN physical resources allocated across the multiple spectrum bands under consideration at a given site, as well as across the sites in a cluster or service area and in active operation as well as such resources being consumed by the active data connections associated with the users/devices. For example, the RAN physical resources are pooled across the radio carriers within the licensed and unlicensed bands for dynamic allocation, reservation and modification based on the time-of-day traffic patterns as well as the mobility dynamics in the 5G service area.

RAN-DAF 608 receives triggers from CDDAF-D 606 based on its internal policy driven methods (periodic or predefined triggers) to drive energy efficiency savings that can be achieved at a cell or cluster level based on cell-level energy consumption configuration 816 and by taking proactive triggers at RAN 614. Thus, in response to cell-level energy consumption configuration 816, RAN-DAF 608 initiates a trigger 820 to RAN 614 to enable at least a portion of the energy consumption configuration at RAN 614 (e.g., cell switching, band switch off, band-PA off, carrier off, flow redirection based on bearer/QoS/density etc.). For instance, RAN-DAF 608 initiates trigger 820 to RAN 614 to switch off certain specific carriers within the supported bands based on traffic detection patterns, power consumption rules and redirecting power hungry cell traffic to other carriers/cells with resource availability at any given site and/or adjacent sites. RAN-DAF 608 may also instruct the specific network functions within RAN 614 such as the RU/DU/CU that could be running on independent hardware/infrastructure platforms to appropriately trigger their internal power savings and/or sleep mode activations based on the dynamics of switching off the RF carriers. For example, RAN 614 enables 822 advanced sleep mode changes for the targeted duration based on AI driven trigger from RAN-DAF 608

RAN 614 updates 824 its energy data analytics (as in report 804) based on cell-state, site, and service-related changes to RAN-DAF 608. RAN 614 also updates 826 its data analytics (as in report 804) based on RU/DU/CU system/site hardware-resources/sleep-state changes to RAN-DAF 608.

RAN-DAF 608 updates 828 its data analytics based on the feed from RAN cells and changes to CDDAF-D 606. Similarly, TN-DAF 610 updates 830 its energy analytics to CDDAF-D 606; CN-DAF 624 updates 832 its energy analytics to CDDAF-D 606; and CDDAF-D 606 updates 834 its analysis of EE/EC data across the domains and reports its updated regional energy analytics to CDDAF-C 632. CDDAF-C 632 continually tracks and updates 836 EE/EC trending at the national level for actionable insights/offloads etc.

CDDAF-D 606 and RAN-DAF 608 have a periodic exchange 838 via a keep-alive service and ensure updates are current with respect to RAN energy savings.

Lastly, FIG. 6 shows UE 510 is in a steady-state, connected in the network, and active with update/new services.

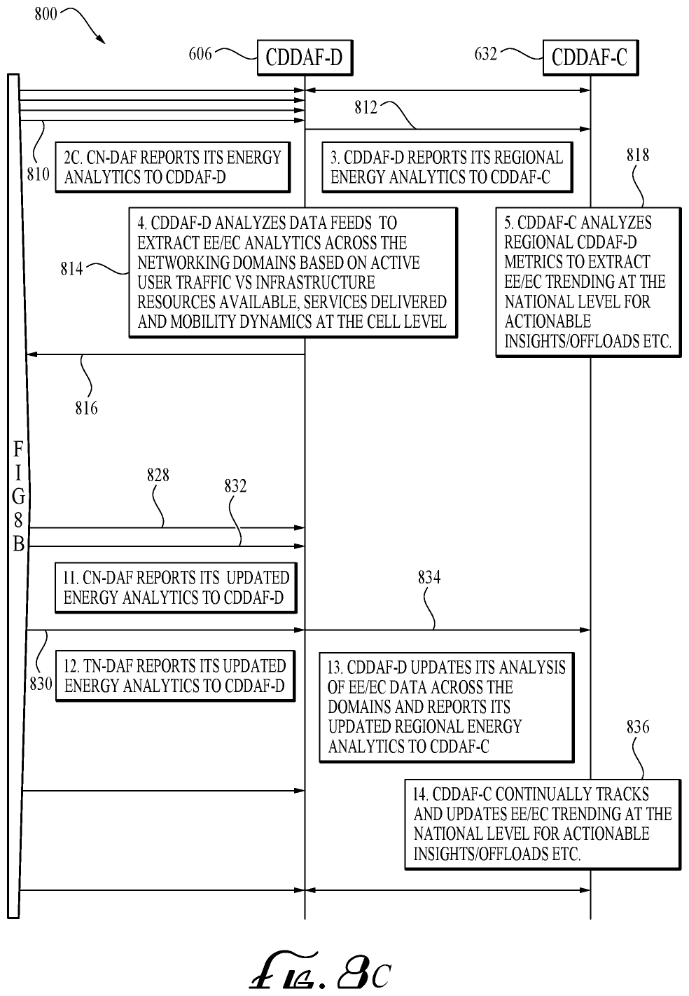

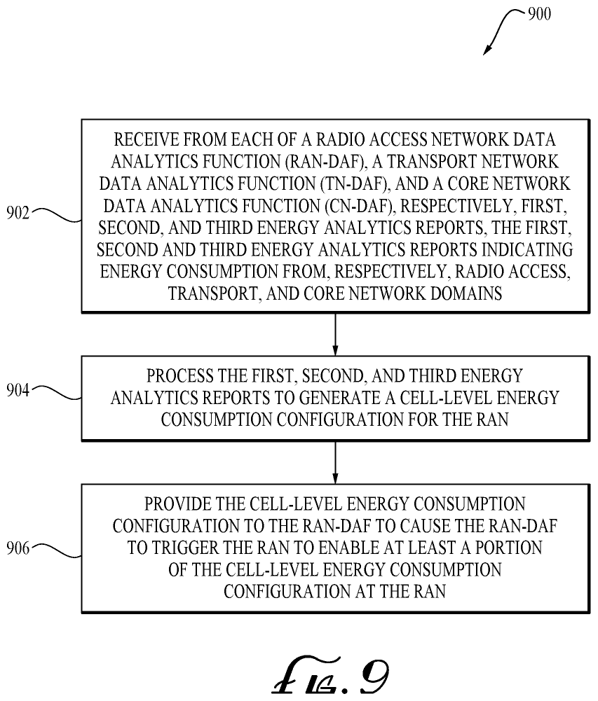

FIG. 9 shows a routine 900, performed by a CDDAF, of reducing energy use for a RAN. In block 902, routine 900 receives from each of a radio access network data analytics function (RAN-DAF), a transport network data analytics function (TN-DAF), and a core network data analytics function (CN-DAF), respectively, first, second, and third energy analytics reports, the first, second and third energy analytics reports indicating energy consumption from, respectively, radio access, transport, and core network domains. In block 904, routine 900 processes the first, second, and third energy analytics reports to generate a cell-level energy consumption configuration for the RAN. In block 906, routine 900 provides the cell-level energy consumption configuration to the RAN-DAF to cause the RAN-DAF to trigger the RAN to enable at least a portion of the cell-level energy consumption configuration at the RAN.

In some embodiments, routine 900 may also optionally include receiving the first energy analytics report triggered in response to a new cell activation, deactivation, or modification; receiving the second energy analytics report triggered in response to a change in access aggregation, switching, or routing; or receiving the third energy analytics report triggered in response to a change in core network aggregation functions, switching, and routing based on selection of core network functions distributed in a data center.

In other embodiments, routine 900 may optionally include correlating time-of-day views of the first, second, and third reports.

In still other embodiments, routine 900 may optionally include reporting regional energy analytics to a central CDDAF.

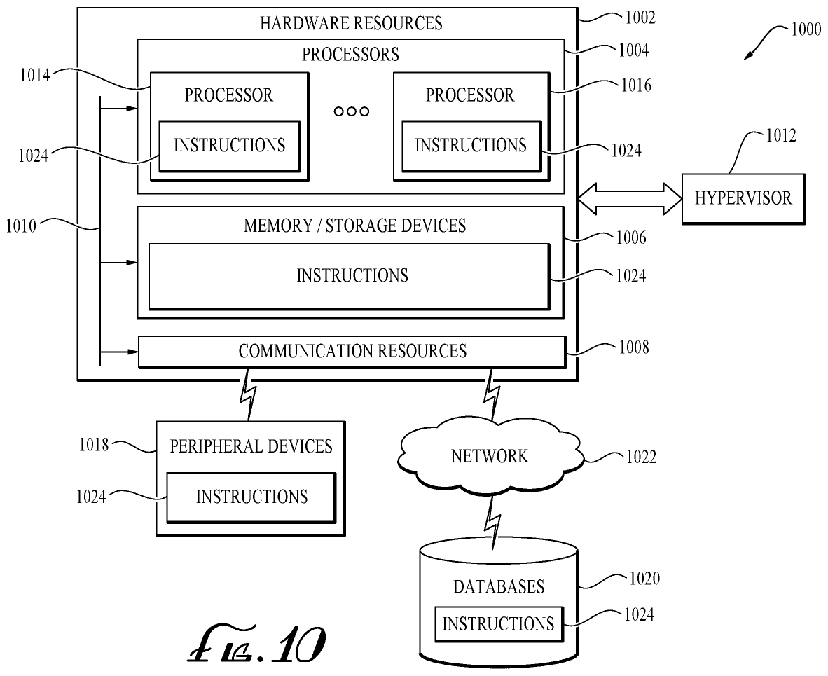

FIG. 10 is a block diagram illustrating components 1000 configured to provide CDDAF 204 (FIG. 2 and FIG. 3) or other data analytics function (e.g., CN-DAF 210), according to some example embodiments. Components 1000 are able to read instructions from a machine-readable or computer-readable medium (e.g., a non-transitory machine-readable storage medium) and perform any one or more of CDDAF tasks discussed herein, including routing 900 (FIG. 9).

Specifically, FIG. 10 shows a diagrammatic representation of hardware resources 1002 including one or more processors 1004 (or processor cores), one or more memory/storage devices 1006, and one or more communication resources 1008, each of which may be communicatively coupled via a bus 1010. For embodiments where node virtualization (e.g., NFV) is utilized, a hypervisor 1012 may be executed to provide an execution environment for one or more network slices/sub-slices to utilize the hardware resources 1002.

Processors 1004 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1014 and a processor 1016.

Memory/storage devices 1006 may include main memory, disk storage, or any suitable combination thereof. Memory/storage devices 1006 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

Communication resources 1008 may include interconnection or network interface components or other suitable devices to communicate with one or more peripheral devices 1018 or one or more databases 1020 via a network 1022. For example, communication resources 1008 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1024 may comprise software, a program, an application, an applet, an app, or other executable code for causing at least any of processors 1004 to perform any one or more of SABR engine tasks discussed herein. Instructions 1024 may reside, completely or partially, within at least one of processors 1004 (e.g., within the processor's cache memory), memory/storage devices 1006, or any suitable combination thereof. Furthermore, any portion of instructions 1024 may be transferred to hardware resources 1002 from any combination of peripheral devices 1018 or databases 1020. Accordingly, memory of the processors 1004, memory/storage devices 1006, peripheral devices 1018, and databases 1020 are examples of computer-readable and machine-readable media.

Given LTE wireless technology will exist for several years to recoup the huge investments made by global carriers, the CDDAF+CN-DAF framework will allow the integrated services exposure function NEF+SCEF to trigger the corresponding network functions in 5GC and EPC core domains. Such dynamic triggers based on data insights from a converged domain will help with the real time selection of the best possible control and user plane functions as mobile users switch between multiple radio access technologies due to underlying radio spectrum as well as coverage issues

As more data becomes available to CDDAF 204 via domain specific network functions, the ability for a service provider to geo-optimize the use of their network and OSS/BSS infrastructure resources as well as the end user services based on such data insights becomes extremely pivotal to their overall operational and business success. Hence the need for CDDAF and its interfaces with local/regional/national domain specific analytical functions becomes useful to drive targeted services and in turn improve their bottom-line revenue opportunities.

Skilled persons will appreciate that many changes may be made to the details of the above-described embodiments without departing from the underlying principles of the invention. The scope of the present invention should, therefore, be determined only by the claims and equivalents thereof.

What is claimed is:

1. A method, performed by a converged domain data analytics function (CDDAF), of reducing energy use for a radio access network (RAN), the method comprising:
receiving from each of a radio access network data analytics function (RAN-DAF), a transport network data analytics function (TN-DAF), and a core network data analytics function (CN-DAF), respectively, first, second, and third energy analytics reports, the first, second and third energy analytics reports indicating energy consumption from, respectively, radio access, transport, and core network domains;
processing the first, second, and third energy analytics reports to generate a cell-level energy consumption configuration for the RAN; and
providing the cell-level energy consumption configuration to the RAN-DAF to cause the RAN-DAF to trigger the RAN to enable at least a portion of the cell-level energy consumption configuration at the RAN.

2. The method of claim 1, in which the first energy analytics report includes information indicating physical resources utilized in a serving cell.

3. The method of claim 1, in which the second energy analytics report includes information indicating physical resources utilized across a transport network serving the RAN.

4. The method of claim 1, in which the third energy analytics report includes information indicating physical resources utilized across core network functions in a 5G core network serving control and user plane functions associated with the RAN.

5. The method of claim 1, in which the receiving comprising receiving the first energy analytics report triggered in response to a new cell activation, deactivation, or modification.

6. The method of claim 1, in which the receiving comprising receiving the second energy analytics report triggered in response to a change in access aggregation, switching, or routing.

7. The method of claim 1, in which the receiving comprising receiving the third energy analytics report triggered in response to a change in core network aggregation functions, switching, and routing based on selection of core network functions distributed in a data center.

8. The method of claim 1, in which the cell-level energy consumption configuration comprises a time-of-day CDDAF correlated view of core-RAN network signaling events associated with registered user equipment and their data connections towards core network functions within a RAN serving area.

9. The method of claim 1, in which the cell-level energy consumption configuration comprises a time-of-day CDDAF correlated view of user equipment active data connections and associated QoS flows.

10. The method of claim 1, in which the cell-level energy consumption configuration includes a time-of-day CDDAF correlated view of RAN physical resources allocated across the multiple spectrum bands.

11. The method of claim 1, in which the providing the cell-level energy consumption configuration to the RAN-DAF comprises correlating time-of-day views of the first, second, and third reports.

12. The method of claim 1, in which the CDDAF is a regional CDDAF configured to communicate with a central CDDAF, the method further comprising reporting regional energy analytics to the central CDDAF.

13. A non-transitory computer-readable storage medium of a converged domain data analytics function (CDDAF), the non-transitory computer-readable storage medium configured to reduce energy use for a radio access network (RAN), the computer-readable storage medium including instructions that when executed by the CDDAF, cause the CDDAF to:
receive from each of a radio access network data analytics function (RAN-DAF), a transport network data analytics function (TN-DAF), and a core network data analytics function (CN-DAF), respectively, first, second, and third energy analytics reports, the first, second and third energy analytics reports indicating energy consumption from, respectively, radio access, transport, and core network domains;
process the first, second, and third energy analytics reports to generate a cell-level energy consumption configuration for the RAN; and
provide the cell-level energy consumption configuration to the RAN-DAF to cause the RAN-DAF to trigger the RAN to enable at least a portion of the cell-level energy consumption configuration at the RAN.

14. The computer-readable storage medium of claim 13, in which the first energy analytics report includes information indicate physical resources utilized in a serving cell.

15. The computer-readable storage medium of claim 13, in which the second energy analytics report includes information indicate physical resources utilized across a transport network serving the RAN.

16. The computer-readable storage medium of claim 13, in which the third energy analytics report includes information indicate physical resources utilized across core network functions in a 5G core network serving control and user plane functions associated with the RAN.

17. The computer-readable storage medium of claim 13, in which the receive comprises receiving the first energy analytics report triggered in response to a new cell activation, deactivation, or modification.

18. The computer-readable storage medium of claim 13, in which the receive comprising receiving the second energy analytics report triggered in response to a change in access aggregation, switching, or routing.

19. The computer-readable storage medium of claim 13, in which the instruction further configure the CDDAF to receive the third energy analytics report triggered in response to a change in core network aggregation functions, switching, and routing based on selection of core network functions distributed in a data center.

20. The computer-readable storage medium of claim 13, in which the cell-level energy consumption configuration comprises a time-of-day CDDAF correlated view of core-RAN network signal events associated with registered user equipment and their data connections towards core network functions within a RAN serving area.

21. The computer-readable storage medium of claim 13, in which the cell-level energy consumption configuration comprises a time-of-day CDDAF correlated view of user equipment active data connections and associated QoS flows.

22. The computer-readable storage medium of claim 13, in which the cell-level energy consumption configuration includes a time-of-day CDDAF correlated view of RAN physical resources allocated across the multiple spectrum bands.

23. The computer-readable storage medium of claim 13, in which the providing the cell-level energy consumption configuration to the RAN-DAF comprises correlate time-of-day views of the first, second, and third reports.
